(19) United States
(12) Patent Application Publication
(10) Pub. No.: US 2024/0120855 A1
(43) Pub. Date: Apr. 11, 2024

(54) DRIVE STAGE

(71) Applicant: SEIKO EPSON CORPORATION, Tokyo (JP)

(72) Inventor: Tomohisa IWAZAKI, SUWA-GUN SHIMOSUWA-MACHI (JP)

(21) Appl. No.: 18/373,982

(22) Filed: Sep. 28, 2023

(30) Foreign Application Priority Data
Oct. 7, 2022 (JP) 2022-162178

(51) Int. Cl. H02N 2/00; H02N 2/02

(52) U.S. Cl. CPC H02N 2/006; H02N 2/004; H02N 2/026

(57) ABSTRACT

A drive stage includes a base section that has a drive surface, a table section that has two vibrators pressed to transmit drive force to the drive surface and that moves relative to the base section, and a first guide section and a second guide section that guide a movement direction of the table section, wherein the two vibrators are located between the first guide section and the second guide section and the directions in which the two vibrators are pressed are opposite to each other with respect to a direction in which the first guide section and the second guide section are aligned.

The present application is based on, and claims priority from JP Application Serial Number 2022-162178, filed Oct. 7, 2022, the disclosure of which is hereby incorporated by reference herein in its entirety.

### BACKGROUND

### 1. Technical Field

The present disclosure relates to a drive stage.

### 2. Related Art

For example, JP-A-2019-97346 discloses a vibration motor in which the first and second vibrators, vibrated by a piezoelectric element provided in a fixed section, are pressed against a movable section with a friction member to move the movable section in a direction along a guide member.

However, in the vibration motor described in JP-A-2019-97346, the first vibrator and the second vibrator are located with a guide member between them and the direction of pressure toward the friction member is the same direction, so there is a risk of failure if the load balance between the first vibrator and the second vibrator becomes unbalanced.

### SUMMARY

A drive stage includes a base section that has a drive surface; a table section that has two vibrators being pressed to transmit drive force to the drive surface and that moves relative to the base section; and a first guide section and a second guide section that guide a movement direction of the table section, wherein the two vibrators are located between the first guide section and the second guide section and directions in which the two vibrators are pressed are opposite to each other with respect to a direction in which the first guide section and the second guide section are aligned.

### BRIEF DESCRIPTION OF THE DRAWINGS

FIG. 1 is a perspective view showing overall configuration of a drive stage according to a first embodiment.

FIG. 2 is a plan view showing configuration of the drive stage according to the first embodiment.

FIG. 3 is a cross-sectional view of A1-A1 line in FIG. 2.

FIG. 4 is a perspective view showing configuration of a piezoelectric motor.

FIG. 5 is a plan view showing configuration of a vibrator.

FIG. 6 is a plan view showing configuration of the drive stage according to a second embodiment.

FIG. 7 is a cross-sectional view of A2-A2 line in FIG. 6.

FIG. 8 is a plan view showing configuration of the drive stage according to a third embodiment.

FIG. 9 is a cross-sectional view of A3-A3 line in FIG. 8.

### DESCRIPTION OF EMBODIMENT

### 1. First Embodiment

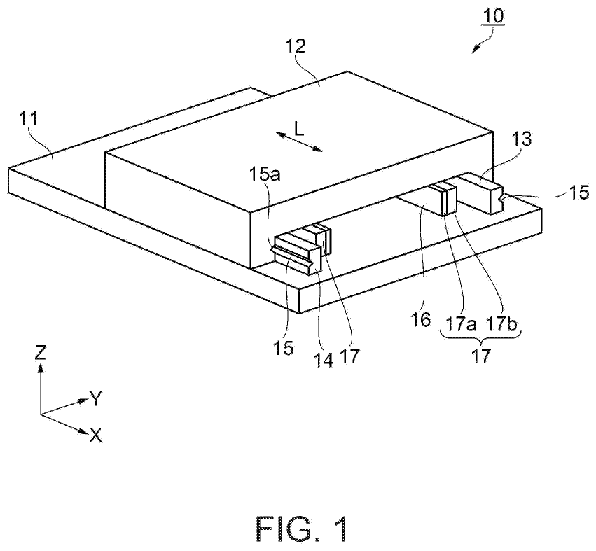

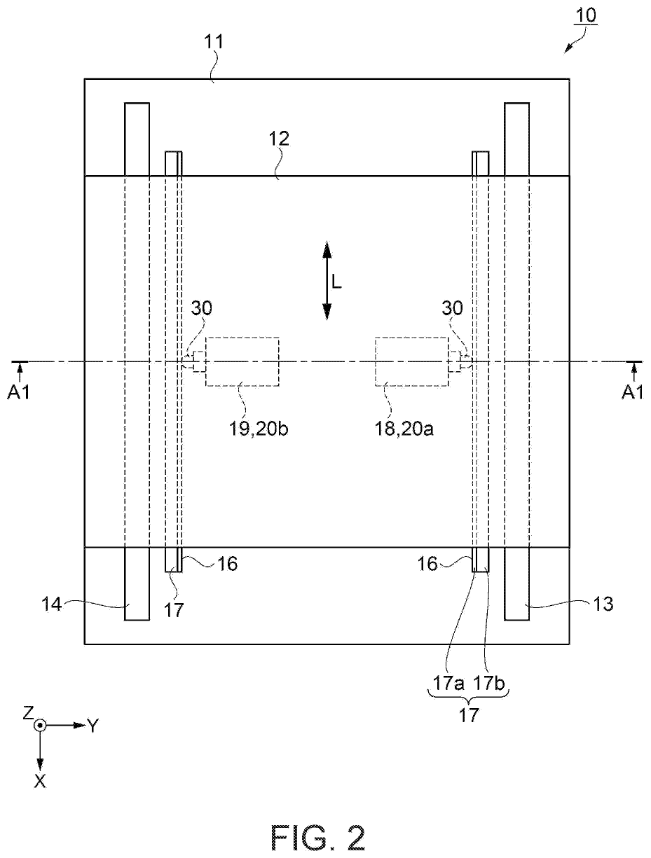

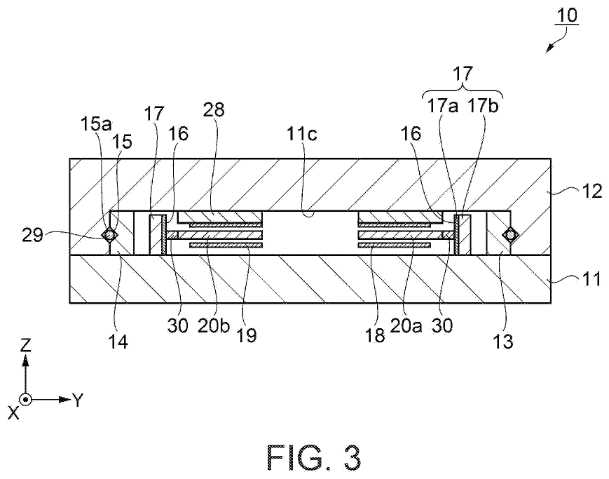

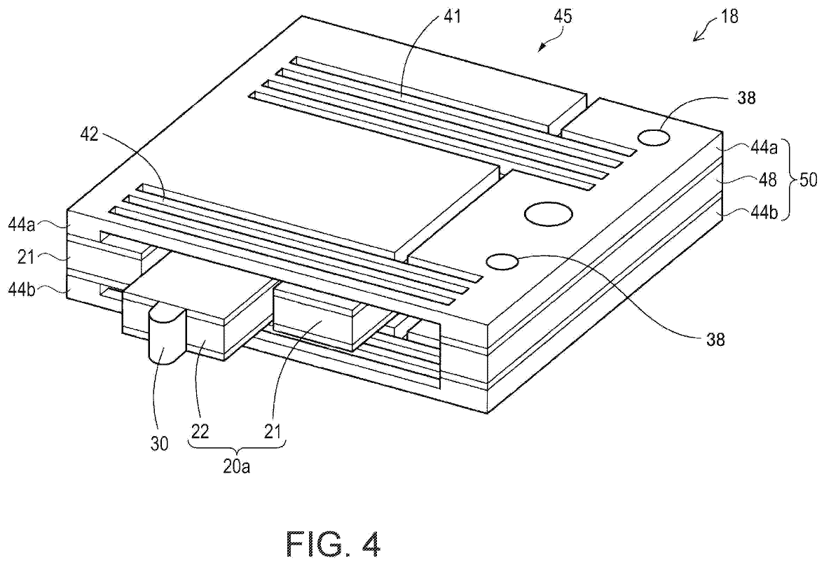

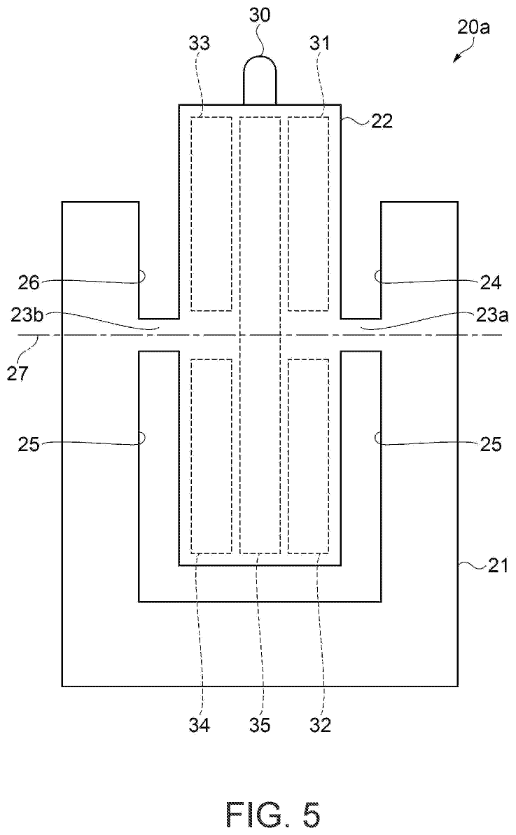

First, a drive stage 10 according to the first embodiment will be described with reference to FIG. 1 to FIG. 3. For convenience of explanation, an X-axis, a Y-axis, and a Z-axis are shown as three axes orthogonal to each other in the following figures, except for FIG. 4 and FIG. 5. A direction along the X axis is referred to as an “X direction”, a direction along the Y axis is referred to as a “Y direction”, and a direction along the Z axis is referred to as a “Z direction”. In addition, an arrow mark direction of each axis is also referred to as a “plus direction”, and an opposite direction to the arrow mark direction is also referred to as a “minus direction”. The plus Z direction is referred to as “upper”, and the minus Z direction is referred to as “lower”.

As shown in FIG. 1 to FIG. 3, a drive stage 10 in this embodiment has a base section 11 having drive surfaces 16, and a table section 12. The table section 12 has two vibrators 20a and 20b that are pressed and transmit drive force to the drive surfaces 16, and moves relative to the base section 11.

The base section 11 has, on the top surface of the base section 11, which is a surface to the table section 12 side, a first guide section 13 and a second guide section 14 that guide movement of the table section 12 in the directions of arrows L, which is the movement direction of the table section 12, and a pressure receiving section 17 having the drive surfaces 16 which are contacted by protruding sections 30 of the first and second piezo motors 18 and 19 provided on the table section 12.

The first guide section 13 and the second guide section 14 extend in the X directions, which are the directions of the arrows L, and are located side by side in the Y direction. Guide rails 15 are provided on side surfaces of the first guide section 13 and the second guide section 14 to move the table section 12 in the exact direction of movement.

There are two pressure receiving sections 17, each extending in the X direction and aligned in the Y direction, located between the first guide section 13 and the second guide section 14. The pressure receiving section 17 is composed of a hard section 17a and a fixed section 17b. The hard section 17a is located on the side surface of the pressure receiving section 17 that is opposite to the guide sections 13 and 14 and includes the drive surface 16 that contacts the protruding section 30 of the piezoelectric motors 18 and 19. The hard section 17a is made of a harder material than the fixed section 17b so that it will not be deformed or scraped by contact with the protruding section 30.

The table section 12 has a recess section 11c which opens toward the base section 11. The first piezoelectric motor 18 and the second piezoelectric motor 19 are fixed at the X direction center of the recess section 11c, between the first guide section 13 and the second guide section 14. More specifically, the first piezoelectric motor 18 and the second piezoelectric motor 19 are fixed to holding sections 28, which is on the inner bottom surface of the recess section 11c, by using screws or the like.

The first piezoelectric motor 18 is fixed to the holding section 28 with the protruding section 30 of the first piezoelectric motor 18 pressed against the drive surface 16 of the pressure receiving section 17 that is located on the first guide section 13 side. The vibrator 20a of the first piezoelectric motor 18 is pressed in the minus Y direction. The second piezoelectric motor 19 is fixed to the holding section 28 with the protruding section 30 of the second piezoelectric motor 19 pressed against the drive surface 16 of the pressure receiving section 17 that is located on the second guide section 14 side. The vibrator 20b of the second piezoelectric motor 19 is pressed in the plus Y direction. In other words, the directions in which the two vibrators 20a and 20b are pressed are the opposite of each other in the direction in which the first guide section 13 and the second guide section 14 are aligned. Therefore, even if loads applied to the two vibrators 20a and 20b are unbalanced, the loads can be offset, thus reducing the occurrence of failures. In this embodiment, the directions in which the two vibrators 20a and 20b are pressed face each other.

The distance between the two guide sections 13 and 14 can be increased by placing the two piezoelectric motors 18 and 19 between the two guide sections 13 and 14. Thereby, rattling between the base section 11 and the table section 12 as they move relative to each other can be reduced, and concentration of the load on the two vibrators 20a and 20b can also be reduced, which can further reduce the occurrence of failures.

Guide rails 15a for moving the table section 12 in the exact movement direction are provided at both end portions in the Y direction of the recess section 11c of the table section 12, at positions facing the guide rails 15 provided on the guide sections 13 and 14. Bearings 29 are located between the guide rails 15 of the base section 11 and the guide rails 15a of the table section 12 to enable the table section 12 to move smoothly in the movement direction.

The drive stage 10 in this embodiment is configured with a pair of piezoelectric motors 18 and 19, but is not limited to this and can be configured with a plurality of pairs of piezoelectric motors 18 and 19 aligned in the X direction.

Since the structure of the first piezoelectric motor 18 and the second piezoelectric motor 19, and the vibrator 20a provided in the first piezoelectric motor 18 and the vibrator 20b provided in the second piezoelectric motor 19 are exactly the same, the first piezoelectric motor 18 and the vibrator 20a will be explained with reference to FIG. 4 and FIG. 5.

As shown in FIG. 4, the first piezoelectric motor 18 includes a vibrator 20a, a biasing section 45, a fixing section 50, and the like. The vibrator 20a is composed of a vibrating body 22 having a piezoelectric body that serves as a vibration source, a holding section 21 that holds the vibrating body 22, and the like. The vibrating body 22 has a rectangular shape. Details of the vibrator 20a will be described later.

The biasing section 45 is composed of a pair of parallel springs 44a and 44b, located above and below the vibrator 20a. One end portion of the parallel spring 44a is integrated as the fixing section 50, and the other end portion of the parallel spring 44a is connected to the holding section 21 of the vibrator 20a. The parallel spring 44a has plate springs 41 and 42 extending in the direction of the short side of the vibrating body 22, which bias the vibrator 20a in a direction of pressing the protruding section 30 toward the pressure receiving section 17 of the base section 11. The plate spring 41 is a plurality of plate springs provided on the rear end side of the vibrating body 22, and the plate spring 42 is a plurality of plate springs provided on the front-end side of the vibrating body 22. The parallel spring 44b provided below the vibrator 20a has the same configuration.

The parallel springs 44a and 44b are provided to sandwich the vibrator 20a from above and below, and are configured to bias the vibrator 20a in the longitudinal direction of the vibrating body 22. In other words, the biasing section 45 connects the holding section 21, including the vibrating body 22, to the fixing section 50 in a state of biasing the holding section 21 in the direction of the protruding section 30.

The fixing section 50 is composed of a base material 48, parallel springs 44a, 44b, and the like. The fixing section 50 is integrated with the parallel spring 44a and the parallel spring 44b overlapping above and below the base material 48. It is then screwed and fixed to the holding section 28 of the table section 12 via two screw holes 38. An end portion on the opposite side of the fixing section 50 in the vibrator 20a has the parallel spring 44a and the parallel spring 44b overlapping and integrated above and below the holding section 21.

As shown in FIG. 5, the vibrator 20a has the holding section 21, the vibrating body 22, and the protruding section 30. The holding section 21 has a rectangular shape and is made of a silicon substrate as a suitable example. In a preferred example, the biasing section 45 and the fixing section 50 are also made of silicon substrate, but they are not limited to this, and any material having equivalent physical properties, for example, metal, can be used.

The vibrating body 22 is a rectangularly sectioned portion in the holding section 21, and piezoelectric elements 31 to 35 for driving are located on the back side surface of the vibrating body 22. In detail, the vibrating body 22 is sectioned into a substantially rectangular shape by three notch sections 24, 25, and 26 in the holding section 21, which is a substantially rectangular shape. The vibrating body 22 is connected to the holding section 21 by a pair of support arms 23a and 23b which remain at substantially the center of the longitudinal side of the rectangle shape. A line segment passing through the support arms 23a and 23b and extending in the direction of the short side of the rectangle shape is a center line 27.

Rectangular piezoelectric elements 31 and 32 are located along one long side of the vibrating body 22. The piezoelectric element 31 and the piezoelectric element 32 are arranged in a line symmetrical arrangement with respect to the center line 27. Similarly, rectangular piezoelectric elements 33 and 34 are located along the other long side of the vibrating body 22. The piezoelectric element 33 and the piezoelectric element 34 are arranged in line symmetrical arrangement with respect to the center line 27. The rectangular piezoelectric element 35 is provided in the center of the vibrating body 22 having a length of the connected piezoelectric element 31 and the piezoelectric element 32.

Although not shown in FIG. 5, electrodes for supplying drive signals to the piezoelectric elements 31 to 35 and wiring are provided on the back surfaces of the piezoelectric elements 31 to 35. The same electrical wiring is connected to the piezoelectric element 31 and the piezoelectric element 34, which are located at opposite corners of the vibrating body 22. Similarly, the same electrical wiring is connected to the piezoelectric element 32 and the piezoelectric element 33. Wiring different from the above wiring is connected to the piezoelectric element 35. A common wiring is provided on the lower layer of the piezoelectric elements 31 to 35. In a preferred example, the common wiring is connected to ground potential.

The AC drive signal supplied to the piezoelectric elements 31 and 34 is a first drive signal. The piezoelectric elements 32 and 33 are supplied with a second drive signal whose phase differs by 180 degrees from the first drive signal. The piezoelectric element 35 is supplied with a third drive signal whose phase differs from both the first drive signal and the second drive signal. For example, as the third drive signal, a signal whose phase differs by 90 degrees from the first drive signal is supplied.

By supplying the above drive signals to the piezoelectric elements 31 to 35, the vibrating body 22 bends and vibrates in the short side direction while expanding and contracting in the long side direction. In other words, the piezoelectric elements 31 to 35 vibrate in-plane in the plane of the substrate. Then, when these vibrations are combined, for example, the tip end of the protruding section 30 makes an elliptical motion with a clockwise or counterclockwise elliptical trajectory. The elliptical motion of the protruding section 30 causes the table section 12 to move in the directions of the arrows L.

As described above, in this embodiment of the drive stage 10, the distance between the two guide sections 13 and 14 can be increased by placing the two piezoelectric motors 18 and 19 between the two guide sections 13 and 14. As a result, rattling between the base section 11 and the table section 12, which move relative to each other, can be reduced, and concentration of load on the two vibrators 20a and 20b can also be reduced, thus reducing the occurrence of failures. The directions in which the two vibrators 20a and 20b are pressed are opposite each other, in the direction in which the two guide sections 13 and 14 are aligned. Therefore, even if the load applied to the two vibrators 20a and 20b becomes unbalanced, the loads can be offset, thus further reducing the occurrence of failures.

### 2. Second Embodiment

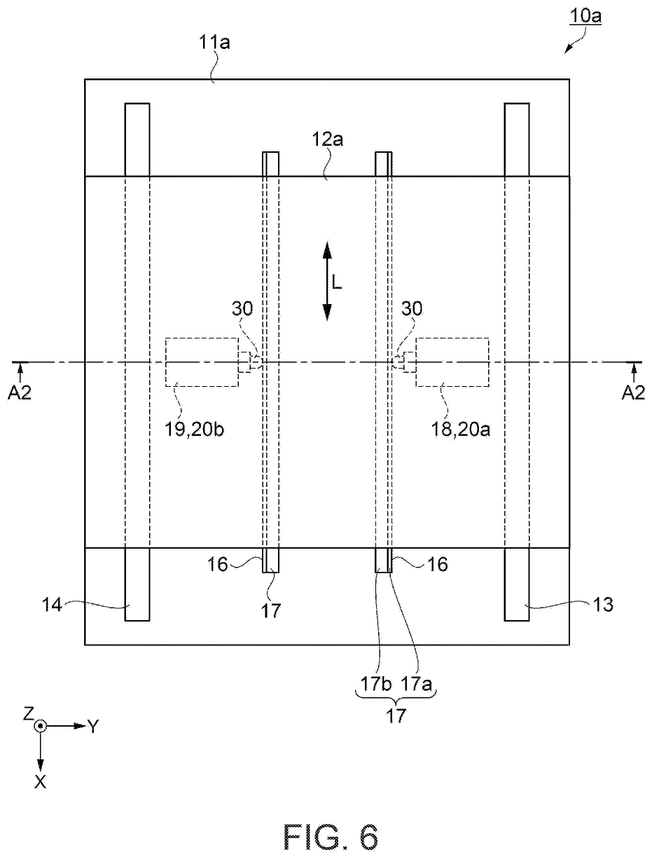

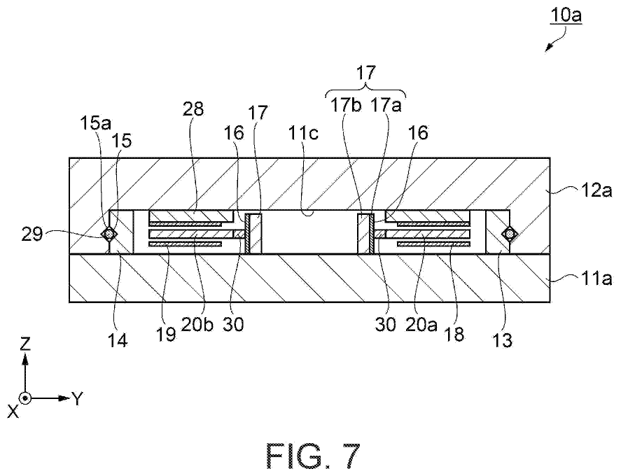

Next, a drive stage 10a for a second embodiment will be described with reference to FIG. 6 and FIG. 7.

The drive stage 10a in this embodiment is similar to the drive stage 10 of the first embodiment, except that the position of the two pressure receiving sections 17 and direction of pressure of the two piezoelectric motors 18 and 19 are different. The description will focus on the differences from the aforementioned first embodiment, and similar matters will be omitted. In FIG. 6 and FIG. 7, the same symbols are used for the same configuration as in the aforementioned embodiment.

In this embodiment of the drive stage 10a, as shown in FIG. 6 and FIG. 7, the two pressure receiving sections 17 in the base section 11a are located in the table section 12a between the first piezoelectric motor 18 and the second piezoelectric motor 19. The drive surface 16 of the pressure receiving section 17 located on the first guide section 13 side is disposed so as to face the first piezoelectric motor 18 and the drive surface 16 of the pressure receiving section 17 located on the second guide section 14 side is disposed so as to face the second piezoelectric motor 19.

The first piezoelectric motor 18 is fixed with the protruding section 30 of the first piezoelectric motor 18 pressed against the drive surface 16 of the pressure receiving section 17 on the first guide section 13 side, and the vibrator 20a of the first piezoelectric motor 18 is pressed in the plus Y direction. In addition, the second piezoelectric motor 19 is fixed with the protruding section 30 of the second piezoelectric motor 19 pressed against the drive surface 16 of the pressure receiving section 17 on the second guide section 14 side, and the vibrator 20b of the second piezoelectric motor 19 is pressed the minus Y direction. In other words, the directions in which the two vibrators 20a and 20b are pressed are opposite to each other with respect to the direction in which the first guide section 13 and the second guide section 14 are aligned, and are directions back-to-back with each other.

Such a configuration can achieve the same effects as the first embodiment described above.

### 3. Third Embodiment

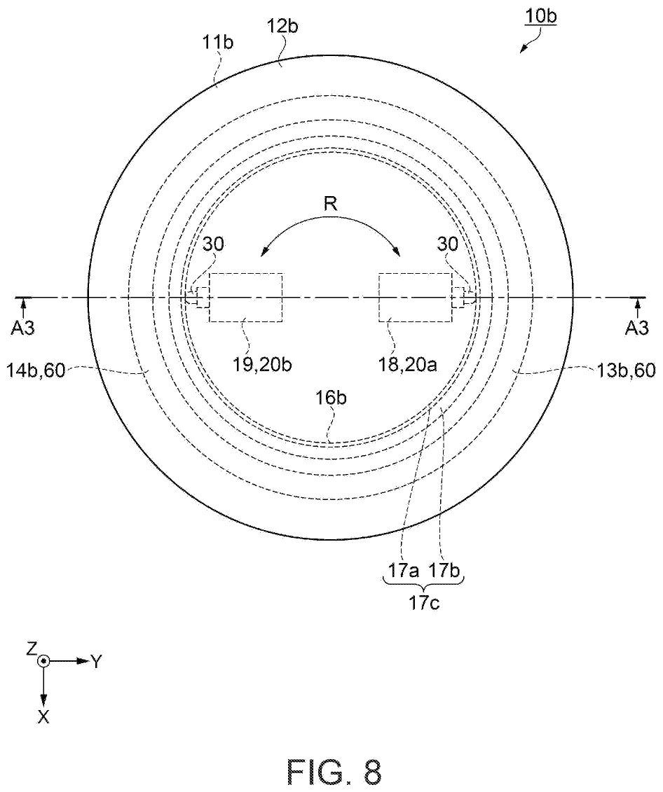

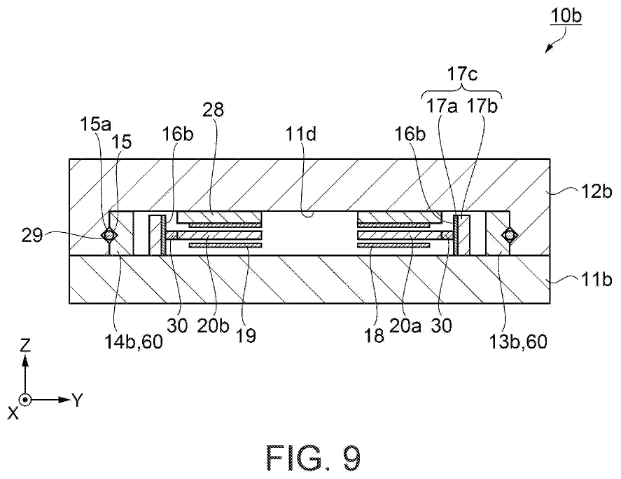

Next, a third embodiment of a drive stage 10b is described with reference to FIG. 8 and FIG. 9.

The drive stage 10b in this embodiment is similar to the drive stage 10 of the first embodiment, except that the structure of a base section 11b, a table section 12b, a first guide section 13b, a second guide section 14b, and a pressure receiving section 17c and a movement direction of the table section 12b are different. The description will focus on the differences from the aforementioned first embodiment, and similar matters will be omitted. In FIG. 8 and FIG. 9, the same symbols are used for the same configuration as in the aforementioned embodiment.

As shown in FIG. 8 and FIG. 9, the drive stage 10b in this embodiment has the base section 11b with a guide section 60 and the pressure receiving section 17c, and the table section 12b to which the first piezoelectric motor 18 and the second piezoelectric motor 19 are fixed. The table section 12b rotates and moves in the directions of arrows R by drive of the first piezoelectric motor 18 and the second piezoelectric motor 19.

The base section 11b has a disk-like shape, and on the top surface, which is the table section 12b side, there is a guide section 60, which is a circular connection form of a first guide section 13b and a second guide section 14b that guides the table section 12b in the directions of arrows R, which are the moving directions of the table section 12b, and the pressure receiving section 17c with which the protruding sections 30 of the first piezoelectric motor 18 and the second piezoelectric motor 19 provided in the table section 12b are in contact.

The table section 12b has disk-like shape and has a circular recess section 11d opening toward the base section 11b side. The first piezoelectric motor 18 and the second piezoelectric motor 19 are fixed side by side in the Y direction, in between the first guide section 13b and the second guide section 14b and at the X direction center of the recess section 11d.

The first piezoelectric motor 18 is fixed with the protruding section 30 of the first piezoelectric motor 18 pressed against the drive surface 16b of the pressure receiving section 17c on the first guide section 13b side, and the vibrator 20a of the first piezoelectric motor 18 is pressed in the minus Y direction. Further, the second piezoelectric motor 19 is fixed with the protruding section 30 of the second piezoelectric motor 19 pressed against the drive surface 16b of the pressure receiving section 17c on the second guide section 14b side, and the vibrator 20b of the second piezoelectric motor 19 is pressed in the plus Y direction. In other words, in a direction in which the first guide section 13b and the second guide section 14b are aligned, the direction in which the two vibrators 20a and 20b are pressed are opposite each other and are directions facing each other.

With this configuration, the same effect as in the first embodiment described above can be achieved.

What is claimed is:

1. A drive stage comprising:
a base section that has a drive surface;
a table section that has two vibrators being pressed to transmit drive force to the drive surface and that moves relative to the base section; and
a first guide section and a second guide section that guide a movement direction of the table section, wherein
the two vibrators are located between the first guide section and the second guide section and
directions in which the two vibrators are pressed are opposite to each other with respect to a direction in which the first guide section and the second guide section are aligned.

2. The drive stage according to claim 1, wherein
the directions in which the two vibrators are pressed are the directions in which the two vibrators face each other.

3. The drive stage according to claim 1, wherein
the directions in which the two vibrators are pressed are back-to-back directions with respect to each other.

4. The drive stage according to claim 1, wherein
the first guide section and the second guide section are connected to each other in a circular form.
